(19) United States
(12) Patent Application Publication
(10) Pub. No.: US 2022/0003241 A1
(43) Pub. Date: Jan. 6, 2022

(54) Pump Assembly

(71) Applicant: Zip Industries (Aust) Pty Ltd, Condell Park, New South Wales (AU)

(72) Inventors: Anish Cherian Mathew, Ingleburn, New South Wales (AU); Gary Noble, Wattle Grove, New South Wales (AU); Kevin Moult, South Maroota, New South Wales (AU)

(21) Appl. No.: 17/292,558

(22) PCT Filed: Nov. 8, 2019
(86) PCT No.: PCT/AU2019/051237

§ 371 Date: May 10, 2021

(30) Foreign Application Priority Data
Nov. 8, 2018 (AU) 2018904256

(51) Int. Cl. F04D 29/24; F04D 29/66; F04D 7/06; B67D 1/10

(52) U.S. Cl. CPC F04D 29/242; B67D 1/10; F04D 7/06; F04D 29/669

(57) ABSTRACT

A pump assembly (10) for pumping boiling water to a dispenser in a drinking water dispensing system, the pump assembly (10) comprising: a pump housing (20) having an inlet (22) for the boiling water and an outlet (24) arranged in fluid communication with the inlet (22); an impeller (30) disposed in the pump housing (20) for rotation about a central axis (23) for driving the water from the inlet (22) to the outlet (24), wherein the inlet (22) is arranged on the central axis (23); and an inducer (40) arranged in the inlet (22) to the pump housing (20) and operatively connected to the impeller (40) for rotation therewith about the central axis (23) to induce the water at the inlet (22) towards the impeller (30) and raise the inlet pressure.

### FIELD

The present invention relates to a pump assembly for a beverage dispensing system, and especially for a dispensing system for dispensing boiling drinking water.

Thus, the invention is particularly designed for use in drinking water dispensing systems, and it will be convenient to describe the invention herein in this exemplary context. It will be appreciated, however, that the invention is not limited to this particular application.

### BACKGROUND

Pumps, such as centrifugal pumps, are well-known mechanical devices for moving or conveying liquids. In a centrifugal pump, a rotating impeller draws the liquid through an inlet of the pump typically arranged on or near its rotational axis and accelerates the liquid radially outwards into the volute chamber or casing of the pump where it then exits through an outlet, thereby transferring rotational kinetic energy of the impeller to hydrodynamic energy.

The pumping of liquids at temperatures close to their boiling point, however, can involve the problem of the liquid undergoing a phase change within the pump due to a reduced pressure to which the liquid is exposed at the inlet- or suction-side of the pump. A phase change of the liquid being pumped to the gas phase inside the pump causes cavitation which, in turn, reduces the efficiency and efficacy of the pump and can also cause damage to the impeller. Thus, if the effects of cavitation become pronounced, this can affect the performance of the pump resulting in reduced volume throughput, an inconsistent flow rate, and potential damage.

It is therefore an object of the invention to provide a new or improved pump assembly for pumping boiling drinking water in a water dispensing system.

### SUMMARY OF INVENTION

According to one aspect, the present invention provides a pump assembly for pumping boiling water to a dispenser in a drinking water dispensing system. The pump assembly includes a pump housing having an inlet for the boiling water and an outlet arranged in fluid communication with the inlet. The pump assembly also includes an impeller disposed in the pump housing for rotation about a central axis for driving the water from the inlet to the outlet. In this respect, the inlet is arranged on the central axis. The pump assembly further includes an inducer arranged in the inlet to the pump housing and operatively connected to the impeller for rotation therewith about the central axis to induce the water at the inlet towards the impeller. The inducer acts to raise the inlet pressure and, in this way, reduces the chance of a phase change occurring as the water is pumped by the impeller, thereby reducing or avoiding the occurrence of cavitation during operation of the pump.

In a preferred embodiment, the impeller and the inducer are mounted on a common shaft. The shaft is preferably comprised of a polished engineered ceramic.

In a preferred embodiment, the inducer comprises a generally elongate stem which extends along the central axis away from the impeller into the inlet, and at least one blade or flight that extends in a helical or screw formation on an outer periphery of the stem. The inducer may include a plurality of blades or flights that extends in a helical or screw formation on the outer periphery of the elongate stem; e.g., the inducer may include a pair of helical blades or flights that extend around the outer periphery of the elongate stem. The helical or screw-shaped form of the at least one blade or flight of the inducer acts to drive the water in the inlet towards and into the impeller. An upstream end of the inducer stem typically terminates in a tapered or rounded cap or nose to promote laminar flow through the inlet.

In a preferred embodiment, the inlet comprises a conduit having a substantially straight length of at least five times its internal diameter, more preferably at least six times its internal diameter, and optionally even longer. This length of the inlet conduit acts to promote laminar flow through and along the inlet by providing a sufficient length of straight travel for the water. The internal diameter of the inlet conduit is preferably in the range of about 5 mm to 15 mm, and more preferably about 10 mm.

In a preferred embodiment, the impeller comprises a central hub for mounting on the shaft and a plurality of radially extending vanes for driving the water centrifugally from the inlet to the outlet. A radially innermost edge of each of the vanes is preferably spaced radially outwards of, or away from, the central hub of the impeller. This configuration has been found to produce surprisingly good pumping performance. Preferably, each of the vanes has a height or a depth in the axial direction that reduces or tapers along a length or extent of the vane in a radial direction from a radially innermost edge to a radially outermost edge thereof. This configuration has also been surprisingly found to promote increased flow rate and improved performance.

In a preferred embodiment, the impeller is comprised of heat resistant polymer for thermal stability. The impeller preferably has a diameter in the range of about 20 mm to 40 mm, more preferably about 30 mm.

In a preferred embodiment, the pump assembly includes an electric motor attached to the pump housing for driving rotation of the inducer and the impeller. In this regard, the electric motor is preferably provided as a brushless induction motor. The shaft of the pump assembly is preferably rigidly fixed to the rotor of the electric motor for rotation therewith.

In a preferred embodiment, the pump assembly includes a bearing device for supporting the shaft for rotation on the central axis.

In a preferred embodiment, the impeller is designed to rotate at a speed in the range of about 6000 to 8000 revolutions per minute (rpm), preferably in the range of about 7000 to 7500 rpm to maintain a suitable flow rate out of the dispenser.

In a particularly preferred embodiment, therefore, the present invention provides a pump assembly for pumping water at a temperature above 96° C. to a dispenser in a vented drinking water dispensing system. The pump assembly includes a pump housing having a water inlet and an outlet in fluid communication with the inlet. The pump assembly also includes an impeller disposed in the pump housing for rotation about a central axis at a no-load speed in the range of about 6000 to 8000 revolutions per minute (rpm) for driving the water from the inlet to the outlet. In this respect, the inlet is arranged on the central axis. The pump assembly further includes an inducer arranged in the inlet to the pump housing and operatively connected to the impeller for rotation therewith about the central axis to induce the water at the inlet towards the impeller and raise the inlet pressure. In this way, the inducer comprises an elongate stem that extends axially away from the impeller into the inlet and a pair of blades or flights that extend in a helical or screw formation on an outer periphery of the stem. The impeller and the inducer are mounted on a common ceramic shaft.

According to yet another aspect, the present invention provides a dispensing system for dispensing boiling drinking water, the system including a pump assembly of any one of the aspects or the embodiments of the invention described above.

### BRIEF DESCRIPTION OF DRAWINGS

For a more complete understanding of the present invention, exemplary embodiments of the invention are explained in more detail in the following description with reference to the accompanying drawing figures, in which like reference signs designate like parts and in which:

FIG. 1 is a perspective view of a pump assembly according to a preferred embodiment;

FIG. 2 is a photograph of the pump assembly of FIG. 1 shown with a silicone elbow fitted over an inlet conduit of the pump assembly;

FIG. 3 is a schematic front view of the pump assembly of FIG. 1 with a pump housing of the pump assembly rendered clear to show an impeller and an inducer of the pump assembly;

FIG. 4 is a perspective view of the impeller and the inducer;

FIG. 5 is front view of the impeller and the inducer shown mounted on a common shaft;

FIG. 6 is a sectional view through the inducer, the impeller and the shaft taken along line D-D of FIG. 5.

FIG. 7 is a cross-sectional view taken longitudinally through the pump assembly of FIG. 1;

FIG. 8 is a perspective view of the pump assembly of FIG. 1 shown with the silicone elbow fitted over the inlet;

FIG. 9 is front view of the impeller and the inducer mounted on the shaft according to another embodiment;

FIG. 10 is a side view of the impeller, the inducer and the shaft of FIG. 9;

FIG. 11 is a sectional detail view through the inducer, taken along line E-E of FIG. 9;

FIG. 12 is a sectional detail view through the inducer, taken along line F-F of FIG. 10; and

FIG. 13 is an exploded parts view of the impeller, inducer and shaft of FIG. 9.

The accompanying drawings are included to provide a further understanding of the present invention and are incorporated in and constitute a part of this specification. The drawings illustrate particular embodiments of the invention and together with the description serve to explain the principles of the invention. Other embodiments of the invention and many of the attendant advantages of the invention will be readily appreciated as they become better understood with reference to the following detailed description.

It will be appreciated that common and/or well understood elements that may be useful or necessary in a commercially feasible embodiment are not necessarily depicted in order to facilitate a more abstracted view of the embodiments. The elements of the drawings are not necessarily illustrated to scale relative to each other. It will also be understood that certain actions and/or steps in an embodiment of a method may be described or depicted in a particular order of occurrences while those skilled in the art will understand that such specificity with respect to sequence is not actually required.

### DESCRIPTION OF EMBODIMENTS

As it is used in this description, it will be appreciated that “boiling water” generally refers to water at or near its boiling point. In the preferred embodiment, the water is at a temperature in the range of about 96° C.-99° C.

Referring to the drawings, a pump assembly 10 according to a preferred embodiment of the invention is illustrated. The pump assembly 10 is suitable for use with a vented drinking water dispensing system (not shown) for pumping boiling water to a dispenser (not shown) in the drinking water dispensing system. Preferably, the pump assembly 10 is configured for pumping water at a temperature of about 98° C.

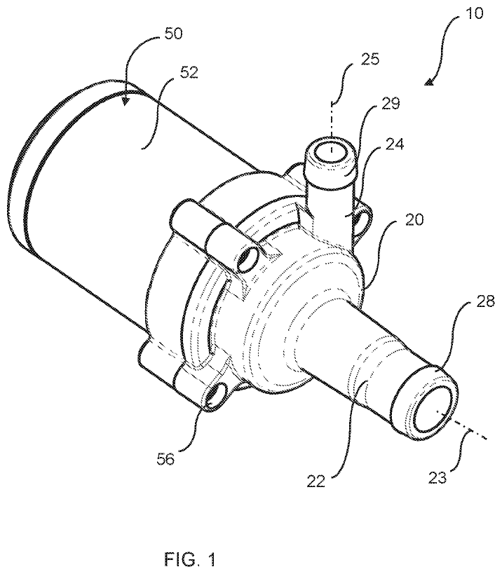

With particular reference to FIG. 1, the pump assembly 10 includes a pump housing 20 having an inlet conduit 22 for the boiling water and an outlet conduit 24 arranged in fluid communication with the inlet conduit 22. Both the inlet conduit 22 and the outlet conduit 24 have respective longitudinally extending central axes 23, 25. The pump housing 20 is comprised of heat resistant polymer for thermal stability during operational pumping of the boiling water.

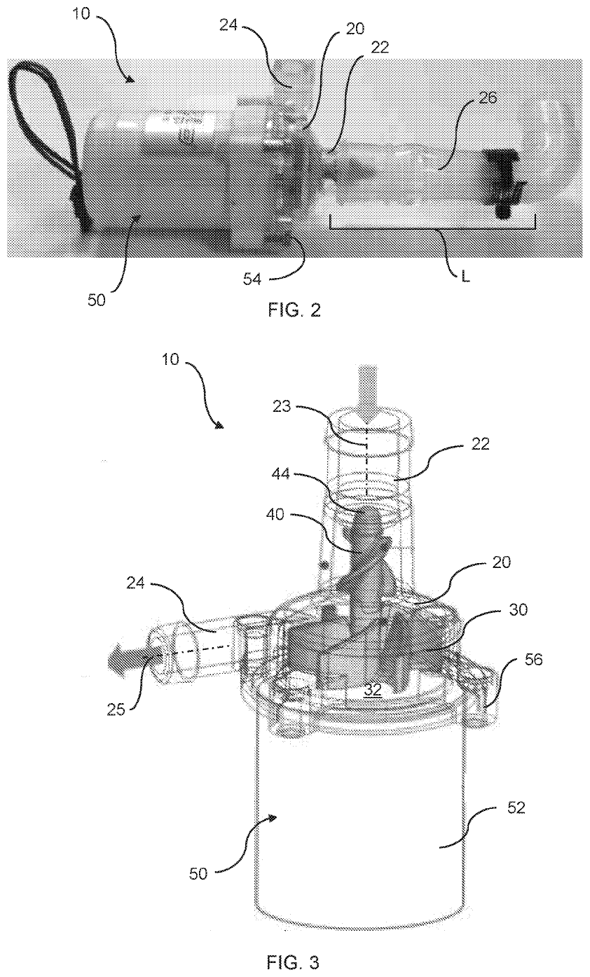

With reference to FIG. 2, silicone tubing in the form of a silicone elbow 26 is configured to fit over the inlet conduit 22 so that the inlet conduit 22 is arranged in fluid communication with a tank (not shown) configured to store the boiling water. The fitted straight section of the silicone elbow 26 together with the inlet conduit 22 define a substantially straight length L of at least five times the internal diameter of the inlet conduit 22, and preferably six times the internal diameter of the inlet conduit 22, to promote laminar flow through the inlet conduit 22. In a preferred embodiment, the inlet conduit 22 has an internal diameter preferably in the range of about 5 mm to 15 mm, more preferably about 10 mm. The inlet conduit 22 preferably has an outer diameter in the range of about 10 to 15 mm, more preferably about 13 mm. As best depicted in FIG. 1, a terminal portion surrounding the open end of the inlet conduit 22 forms a lip 28 preferably having an axial width of about 4 mm and an outer diameter of about 14 mm over which the straight section of the silicone elbow 26 is securely fitted.

With reference again to drawing FIG. 1, the outlet conduit 24 of the pump housing 20 is arranged so that its central axis 25 is substantially perpendicular and offset with the central axis 23 of the inlet conduit 22. The outlet conduit 24 has an internal diameter preferably in the range of about 5 mm to 10 mm, more preferably about 6 mm. Silicone tubing (not shown) is configured to fit over the outlet conduit 24 so that the outlet conduit 24 is arranged in fluid communication with the dispenser in the drinking water dispensing system. In a preferred embodiment, the outlet conduit 24 has a straight length in the range of about 15 to 25 mm, more preferably about 18 mm, and an outer diameter in the range of about 5 to 15 mm, more preferably about 9 mm. A terminal portion surrounding the open end of the outlet conduit 24 forms a lip 29 preferably having an axial width of about 5 mm and an outer diameter of about 10 mm over which the silicone tubing is securely fitted.

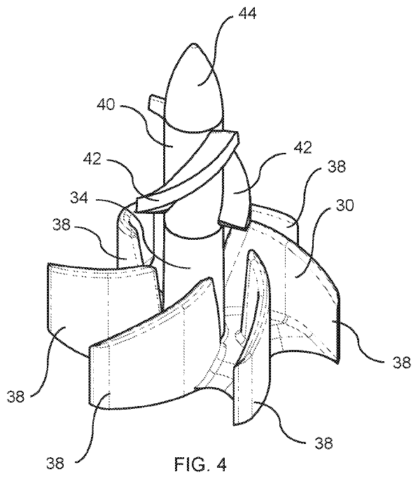

With particular reference to FIG. 3, the pump assembly 10 includes an impeller 30 disposed in the pump housing 20 for rotation about a central axis, that is, the central axis 23 of the inlet conduit 22, for driving the water from the inlet conduit 22 to the outlet conduit 24. The section of the pump housing 20 in which the impeller 30 is disposed preferably defines a cylindrical chamber 32 having an outer diameter in the range of about 15 to 45 mm, more preferably about 31 mm. In this regard, the inlet conduit 22 and the outlet conduit 24 are preferably integrally formed with the section of the pump housing 20 defining the cylindrical chamber 32.

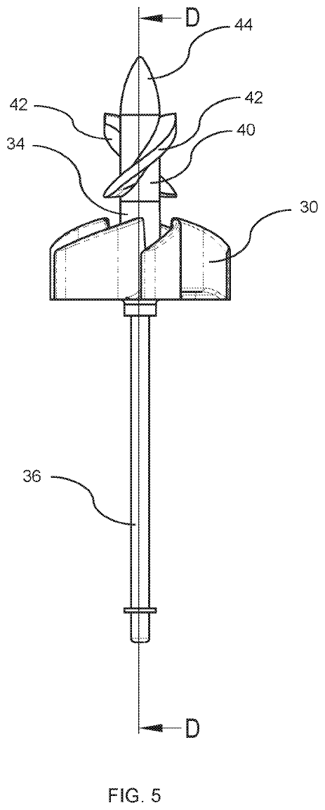

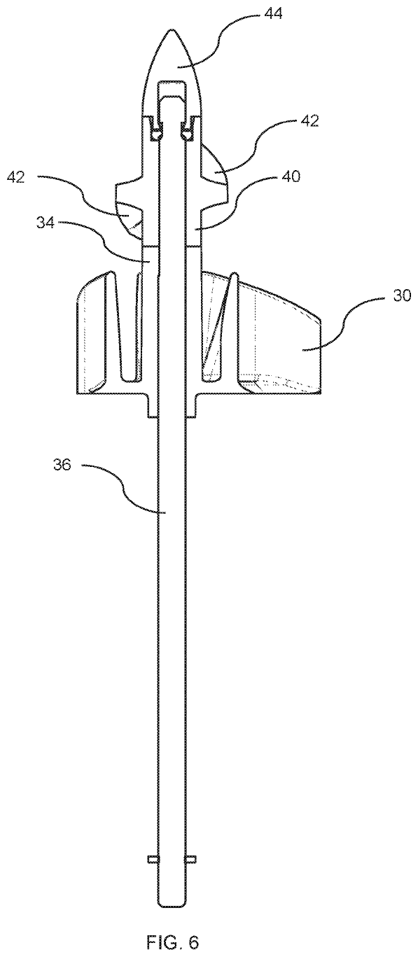

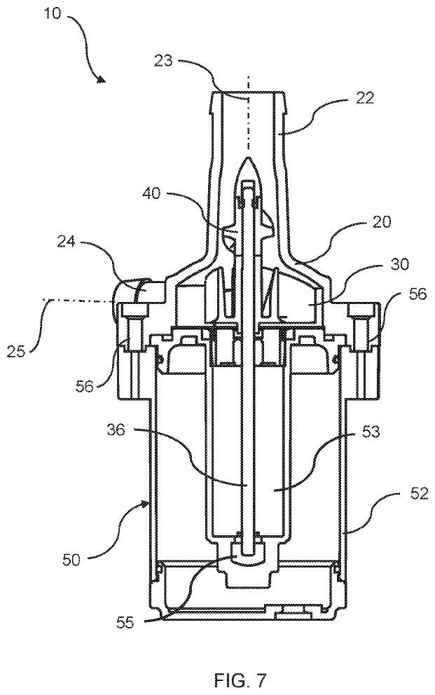

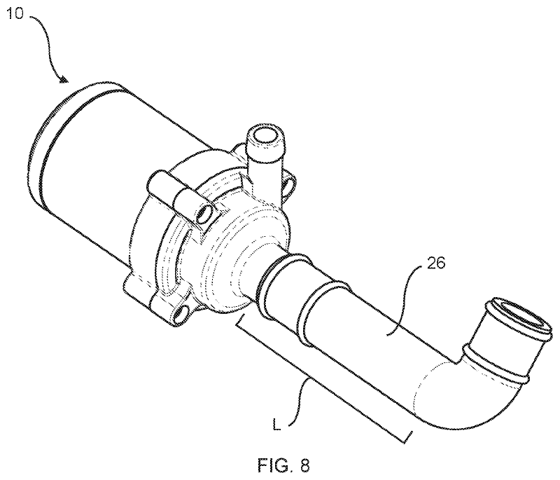

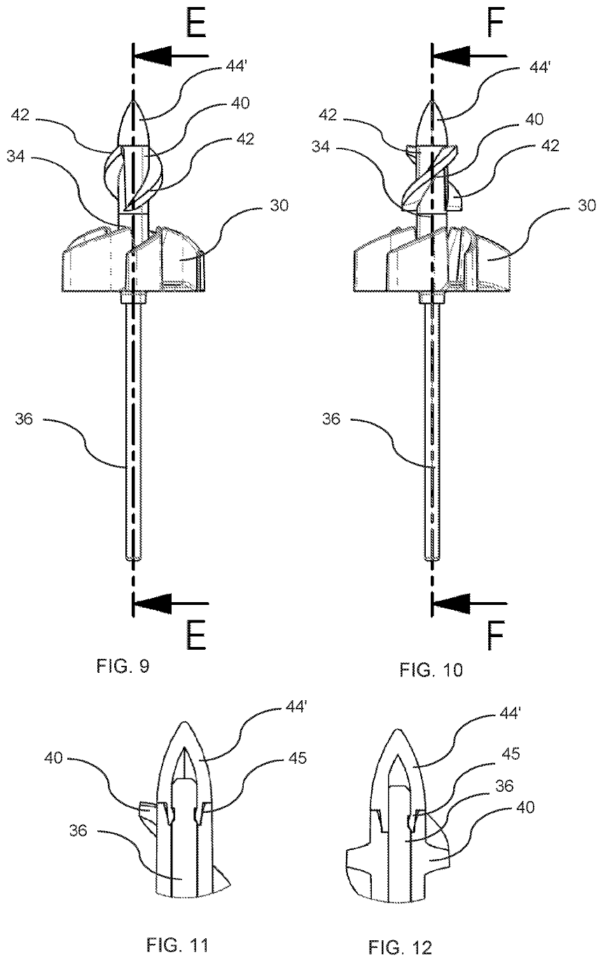

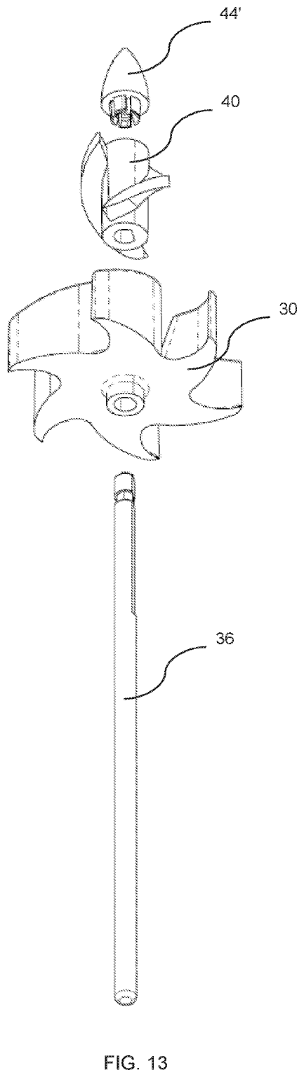

With particular reference to FIG. 4, the impeller 30 has a central hub 34 for mounting on a shaft 36 (shown in FIG. 5) comprised of a ceramic. The impeller 30 includes a plurality of radially extending vanes 38 for driving the water centrifugally from the inlet conduit 22 to the outlet conduit 24. A radially innermost edge of each of the vanes 38 is spaced radially outwards of or away from the central hub 34 of the impeller 30, preferably spaced about 4 mm from the central hub 34. Each of the vanes 38 has a height or depth in the axial direction that reduces or tapers in the radial direction from the radially innermost edge to a radially outermost edge thereof, that is, the height reduces from about 12 mm to 6 mm. Each of the vanes 38 is curved backwardly away from the tangential direction of rotation. Like the pump housing 20, the impeller 30 is comprised of heat resistant polymer and has a diameter in the range of about 20 mm to 40 mm, preferably about 30 mm.

With particular reference to FIGS. 3 to 5, the pump assembly 10 further includes an inducer 40 arranged in the inlet conduit 22 to the pump housing 20 and mounted on the ceramic shaft 36 upstream of the impeller 30. The inducer 40 comprises a generally elongate stem which extends along the central axis 23 of the inlet conduit 22 away from the impeller 30 into the inlet conduit 22. In a preferred embodiment, the longitudinal length of the elongate stem is in the range of about 10 mm to 20 mm, preferably about 15 mm. A downstream portion of the elongate stem is rigidly keyed with a portion extending from the central hub 34 of the impeller 30 so that the inducer 40 rotates with the impeller 30 about the central axis 23 of the inlet conduit 22 to induce the water at the inlet conduit 22 towards the impeller 30 and raise the inlet pressure. The elongate stem has at least one blade or flight 42, preferably two blades or flights, that extends in a helical or screw formation on an outer periphery of the inducer stem. An upstream end of the inducer stem terminates in a tapered or rounded cap or nose 44 to promote laminar flow through the inlet conduit 22. As shown in FIGS. 11 and 12, a nose 44′ according to another embodiment includes a clip adapter portion 45 to enable the nose 44′ to be mounted to the shaft 36.

With reference to FIG. 7, the pump assembly 10 further includes an electric brushless induction motor 50 having a housing 52 attached to the pump housing 20 by way of screws 54 (shown in FIG. 2) threadably engageable in respective aligned screw holes 56 on both the motor housing 52 and the pump housing 20. The motor 50 drives rotation of the impeller 30 and the inducer 40. In this way, the ceramic shaft 36, on which the impeller 30 and the inducer 40 rotate, is rigidly retained with a clip retainer or other fixing means to the rotor 53 of the motor 50 for rotation therewith. To facilitate rotation of the ceramic shaft 36, the pump assembly 10 includes a bearing 55 into which an end of the ceramic shaft 36 is inserted for supporting the ceramic shaft 36 on the central axis 23 of the inlet conduit 22. In this regard, the impeller 30 (and the inducer 40) is designed to rotate (without load) at a speed in the range of about 6000 to 8000 revolutions per minute (rpm), preferably in the range of about 7000 to 7500 rpm, and more preferably 7300 rpm±5%.

According to a preferred embodiment, the motor housing 52 has an axial length of about 43 mm and an outer diameter of about 37 mm. By this arrangement, the total weight of the pump assembly 10 is in the range of about 150 g to 250 g.

Although specific embodiments of the invention are illustrated and described herein, it will be appreciated by those of ordinary skill in the art that a variety of alternative and/or equivalent implementations exist. It should be appreciated that the exemplary embodiment or exemplary embodiments are examples only and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents. Generally, this application is intended to cover any adaptations or variations of the specific embodiments discussed herein.

It will also be appreciated that in this document the terms “comprise”, “comprising”, “include”, “including”, “contain”, “containing”, “have”, “having”, and any variations thereof, are intended to be understood in an inclusive (i.e. non-exclusive) sense, such that the process, method, device, apparatus or system described herein is not limited to those features or parts or elements or steps recited but may include other elements, features, parts or steps not expressly listed or inherent to such process, method, article, or apparatus. Furthermore, the terms “a” and “an” used herein are intended to be understood as meaning one or more unless explicitly stated otherwise. Moreover, the terms “first”, “second”, etc. are used merely as labels, and are not intended to impose numerical requirements on or to establish a certain ranking of importance of their objects.

1. A pump assembly for pumping boiling water to a dispenser in a drinking water dispensing system, the pump assembly comprising:
a pump housing having an inlet for the boiling water and an outlet arranged in fluid communication with the inlet;
an impeller disposed in the pump housing for rotation about a central axis for driving the water from the inlet to the outlet, wherein the inlet is arranged on the central axis; and
an inducer arranged in the inlet to the pump housing and operatively connected to the impeller for rotation therewith about the central axis to induce the water at the inlet towards the impeller and raise the inlet pressure.

2. A pump assembly according to claim 1, wherein the impeller and the inducer are mounted on a common shaft comprised of a ceramic.

3. A pump assembly according to claim 1, wherein the inducer comprises a generally elongate stem which extends along the central axis away from the impeller into the inlet, and at least one blade or flight that extends in a helical or screw formation on an outer periphery of the stem.

4. A pump assembly according to claim 4, wherein an upstream end of the inducer stem terminates in a tapered or rounded cap or nose to promote laminar flow through the inlet.

5. A pump assembly according to claim 1, wherein the inlet is a conduit having a substantially straight length of at least five times its internal diameter; and wherein the internal diameter of the inlet conduit is in the range of about 5 mm to 15 mm.

6. A pump assembly according to claim 1, wherein the impeller has a central hub for mounting on the shaft and a plurality of radially extending vanes for driving the water centrifugally from the inlet to the outlet, wherein a radially innermost edge of each of the vanes is spaced radially outwards of or away from the central hub of the impeller.

7. A pump assembly according to claim 6, wherein each of the vanes has a height or depth in the axial direction that reduces or tapers in the radial direction from the radially innermost edge to a radially outermost edge thereof.

8. A pump assembly according to claim 1, wherein the impeller is comprised of heat resistant polymer and has a diameter in the range of about 20 mm to 40 mm.

9. A pump assembly according to claim 1, further comprising an electric motor attached to the pump housing for driving rotation of the inducer and the impeller.

10. A pump assembly according to claim 9, wherein the shaft is rigidly fixed to the rotor of the electric motor for rotation therewith.

11. A pump assembly according to claim 9, further comprising a bearing device for supporting the shaft on the central axis.

12. A pump assembly according to claim 1, wherein the impeller is designed to rotate at a no-load speed in the range of about 6000 to 8000 revolutions per minute (rpm).

13. A pump assembly according to claim 1, wherein the pump assembly is configured for pumping water at a temperature of about 98° C.

14. A pump assembly for pumping water at a temperature above 96° C. to a dispenser in a vented drinking water dispensing system, the pump assembly comprising:
a pump housing having a water inlet and an outlet in fluid communication with the inlet;
an impeller disposed in the pump housing for rotation about a central axis at a no-load speed in the range of about 6000 to 8000 revolutions per minute (rpm) for driving the water from the inlet to the outlet, wherein the inlet is arranged on the central axis;
an inducer arranged in the inlet to the pump housing and operatively connected to the impeller for rotation therewith about the central axis to induce the water at the inlet towards the impeller and raise the inlet pressure, wherein the inducer comprises an elongate stem that extends axially away from the impeller into the inlet and a pair of blades or flights that extend in a helical or screw formation on an outer periphery of the stem;
wherein the impeller and the inducer are mounted on a common ceramic shaft.

15. A dispensing system for dispensing boiling drinking water, the system comprising a pump assembly according to claim 1.

16. A pump assembly according to claim 5, wherein the conduit has substantially straight length of at least six times its internal diameter; and wherein the internal diameter of the inlet conduit is about 10 mm.

17. A pump assembly according to claim 8, wherein the diameter of the impeller is about 30 mm.

18. A pump assembly according to claim 9, wherein the electric motor is a brushless induction motor.

19. A pump assembly according to claim 12, wherein the impeller is designed to rotate at a no-load speed in the range of about 7000 to 7500 rpm.
